(19) United States
(12) Patent Application Publication
(10) Pub. No.: US 2017/0217069 A1
(43) Pub. Date: Aug. 3, 2017

(54) EXTRUSION MOLDED PRODUCT HAVING CORE MATERIAL

(71) Applicants: Tokiwa Chemical Industries Co., Ltd., Chiba (JP); System Technical Co., Ltd., Chiba (JP)

(72) Inventors: Takashi HIROKAWA, Chiba (JP); Katsuhisa KATO, Chiba (JP)

(73) Assignees: Tokiwa Chemical Industries Co., Ltd., Chiba (JP); System Technical Co., Ltd., Chiba (JP)

(21) Appl. No.: 15/181,550

(22) Filed: Jun. 14, 2016

(30) Foreign Application Priority Data
Jan. 29, 2016 (JP) 2016-14979

(51) Int. Cl. B29C 47/00; B60R 13/04; C08L 53/02; B60R 13/06

(52) U.S. Cl. CPC B29C 47/0004; B60R 13/06; B60R 13/043; C08L 53/02; B29K 2021/00

(57) ABSTRACT

A thermoplastic elastomer composition forming the contact portion (6) comprises:
30 to 60 parts by weight of component (a): a block copolymer comprising at least two polymer blocks A mainly comprising a vinyl aromatic compound and at least one polymer block B mainly comprising a conjugated diene compound, and/or a hydrogenated block copolymer obtained by hydrogenating the block copolymer;
10 to 30 parts by weight of component (b): a homopolymer of crystalline ethylene or propylene, or a crystalline copolymer mainly comprising the ethylene or propylene; and
25 to 55 parts by weight of component (c): a rubber softener; and in addition to the above-mentioned (a)+(b)+(c)=100 parts by weight;
3 to 15 parts by weight of component (d): a petroleum resin and/or a hydrogenated petroleum resin obtained by hydrogenation.

### BACKGROUND OF THE INVENTION

Field of the Invention

The present invention relates to an extrusion molded product having a core material, such as a weather strip and a trim, for mounting thereof on a flange around the periphery of an opening of an automobile body, such as a door, a trunk, and a back door.

Description of the Related Art

In an extrusion molded product having a core material for mounting thereof on a flange around the periphery of an opening of an automobile body, such as a door, a trunk, and a back door, a molded product body (1) comprises a grip portion (2) having a generally U-shaped cross section formed by a core material (3) and a coating member (4) of a thermoplastic elastomer composition by a method of extrusion; the grip portion (2) has holding portions (5) formed inside side portions (7) thereof such that the holding portions (5) each project from the coating member (4); As shown by FIG. 9, the molded product body (1) is mounted on a flange (11), being held while the flange (11) and the holding portion (5) are abutting each other. However, the low coefficient of static friction of the surface of the holding portion (5) is liable to cause slippage, and there is a problem that the molded product body (1) falls off the flange (11) easily. In order to solve the above-mentioned problem, an extrusion molded product is proposed, according to which the holding portion (5) has a contact portion (6) of anti-slip thermoplastic elastomer composition on a portion abutting the flange (11) (for example, Patent Literature 1 as listed below).

### PRIOR ART DOCUMENT

Patent Literature 1: Japanese Patent Application Laid-Open Publication No. 2011-25906

### SUMMARY OF THE INVENTION

### Problem to be Solved by the Invention

However, the conventional technique disclosed in the above-mentioned Patent Literature 1 has a problem that in harsh environments, polyethylene mainly contained in the contact layer (6) or a copolymer mainly comprising polyethylene becomes incapable of holding oil, being required to hold more oil than it can, and the oil moves and attaches to the surface of the contact layer (6), thereby decreasing the performance of sealing between the contact portion (6) and the flange (11) as time goes by.

Furthermore, in order for the molded product body (1) to be mounted on the corner portion of the periphery of an opening of an automobile body in such a manner that the molded product body (1) is bent by the corner portion, the coating member (4) and the holding portions (5) are preferably formed of a soft thermoplastic elastomer having type A durometer hardness of 45 to 65. However, since use of the soft thermoplastic elastomer increases the compounding ratio of oil, there is a problem that more and more oil of the thermoplastic elastomer inside the coating member (4) moves to the contact layer (6), and the oil attaches to the surface of the contact portion (6).

The present invention has been made in order to solve the above-mentioned problems, and it is an object of the present invention to provide an extrusion molded product having a core material, wherein at least one of the holding portions (5) has a contact portion (6) formed integrally with the holding portion (5) on a portion abutting a flange (11), wherein the coefficient of static friction of the contact portion (6) is larger than that of the holding portion (5), and the thermoplastic elastomer composition forming the contact portion (6) mainly comprises component (a) consisting of a rubber having a high capability of containing oil, thereby preventing oil from moving and attaching to the surface of the contact portion (6) so as to avoid slippage of the surface of the contact portion (6), and enabling the molded product body (1) to be mounted, without causing the molded product body (1) to fall off the flange (11), on the corner portion of the periphery of an opening of an automobile body in such a manner that the molded product body (1) is bent by the corner portion.

In order to solve the aforesaid problems, an extrusion molded product having a core material is characterized in that the thermoplastic elastomer composition forming the contact portion (6) comprises:

30 to 60 parts by weight of component (a): a block copolymer comprising at least two polymer blocks A mainly comprising a vinyl aromatic compound and at least one polymer block B mainly comprising a conjugated diene compound, and/or a hydrogenated block copolymer obtained by hydrogenating the block copolymer;

10 to 30 parts by weight of component (b): a homopolymer of crystalline ethylene or propylene, or a crystalline copolymer mainly comprising the ethylene or propylene; and

25 to 55 parts by weight of component (c): a rubber softener; and in addition to the above-mentioned (a)+(b)+(c)=100 parts by weight;

3 to 15 parts by weight of component (d): a petroleum resin and/or a hydrogenated petroleum resin obtained by hydrogenation.

Here, it is preferred that the thermoplastic elastomer forming the coating member (4) and the holding portion (5) have type A durometer hardness of 45 to 65.

Since an extrusion molded product having a core material according to the present invention is constructed such that at least one of the holding portions (5) has a contact portion (6) formed integrally with the holding portion (5) on a portion abutting a flange (11), wherein the coefficient of static friction of the contact portion (6) is larger than that of the holding portion (5), there is an advantageous effect that the extrusion molded product does not easily slip along and off the flange (11).

Especially, the thermoplastic elastomer composition forming the contact portion (6) mainly comprises component (a) consisting of a rubber having a high capability of containing oil, and thus, there is an advantageous effect that even in harsh environments, oil is prevented from moving and attaching to the surface of the contact portion (6), which allows the sealing ability of the contact portion (6) to be duly maintained.

Furthermore, even if a soft thermoplastic elastomer having a type A durometer hardness of 45 to 65 is used for the coating member (4) and the holding portion (5) that can be mounted on the corner portion of the periphery of an opening of an automobile body in such a manner as to be bent by the corner portion, there is also an advantageous effect that oil is prevented from moving and attaching to the surface of the contact portion (6), which allows the sealing ability of the contact portion (6) to be duly maintained.

As mentioned above, the contact portion (6) is integrally formed with the holding portion (5) by co-extrusion, which provides an advantageous effect that the molded product body (1) will not fall off the flange (11).

### BRIEF DESCRIPTION OF THE DRAWINGS

FIG. 1 is a sectional view of the molded product body according to an embodiment of the present invention.

FIG. 2 is a sectional view in which the molded product body according to the embodiment according to the present invention is mounted on a flange.

FIG. 3 is a sectional view of the molded product body according to another embodiment of the present invention, in which a hollow seal portion is provided outside a connecting portion, and a contact portion is formed on each of holding portions facing each other from both sides.

FIG. 4 is a sectional view of the molded product body according to another embodiment of the present invention, in which a hollow seal portion is provided outside a side portion.

FIG. 5 is a sectional view of another embodiment according to the present invention, in which a contact portion is formed at a lower position on a first long holding portion and on a second vertical short holding portion.

FIG. 6 is a simplified view showing a series of manufacturing processes of an extrusion molded product according to another embodiment of the present invention, wherein a core material for forming a part of a molded product body is manufactured from a hard synthetic resin.

FIG. 7 is a sectional view of a molded product body, wherein a glass run channel is formed integrally with a lower part of a grip portion.

FIG. 8 is a partial perspective view of a core material according to another embodiment of the present invention, wherein gap portions are cut out and formed in the core material.

FIG. 9 is a sectional view of a conventional molded product body not having a contact portion formed therewith.

### DETAILED DESCRIPTION OF THE PREFERRED EMBODIMENTS

Preferred embodiments of an extrusion molded product according to the present invention will be described hereinafter with reference to the accompanying drawings. The embodiments described below are only examples of the present invention, and thus, the present invention, which is by no means limited to the embodiments, can be realized in all kinds of variants within the technical idea of the present invention.

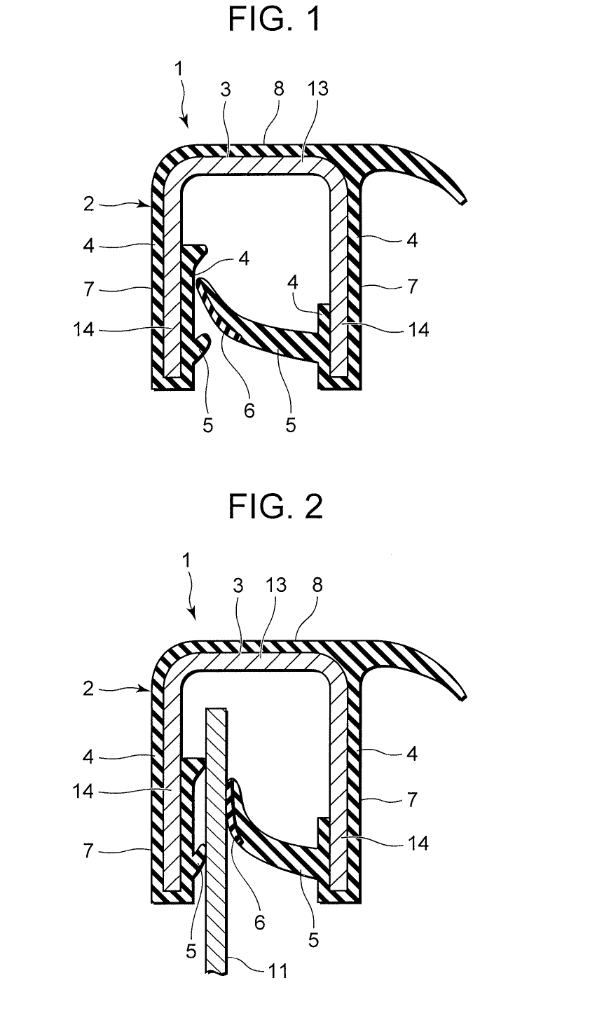

Descriptions will be made on the drawings showing the embodiments of the present invention, and FIG. 1 shows a sectional view of an extrusion molded product having a core material, for mounting thereof on a flange around the periphery of an opening of an automobile body, such as a door, a trunk, and a back door. A molded product body (1) is formed by extruding a core material (3) of a synthetic resin or a metal and a coating member (4) of a thermoplastic elastomer into a grip portion (2) generally U-shaped cross section. In this respect, the coating member (4) is formed on part or entire area of periphery of the core material (3), as required.

Inside the side portions (7) of the grip portion (2) are formed holding portions (5) each protruding from the coating member (4). One of the holding portions (5) has a contact portion (6) formed, like a layer by co-extrusion, on the surface of the tip side thereof that abuts the flange (11). The contact portion (6), which has a coefficient of static friction larger than that of the holding portion (5), is formed of a thermoplastic elastomer composition mainly comprising component (a) that has a high holding force even in harsh environments.

FIG. 2 shows a state of the molded product body (1) in FIG. 1 being mounted on a flange around the periphery of an opening of an automobile body.

As shown in FIG. 2, when the molded product body (1) is mounted on a flange around the periphery of an opening of an automobile body, the holding portions (5), (5) seen on the right and left sides in FIG. 2 are bent respectively, wherein the short holding portion (5) seen on the left side in FIG. 2 elastically abuts, at the distal end thereof, the flange (11) around the periphery of an opening of an automobile body, while the long holding portion (5) seen on the right side in FIG. 2 elastically abuts, at the contact portion (6) provided at the distal end thereof, the flange (11) around the periphery of an opening of an automobile body.

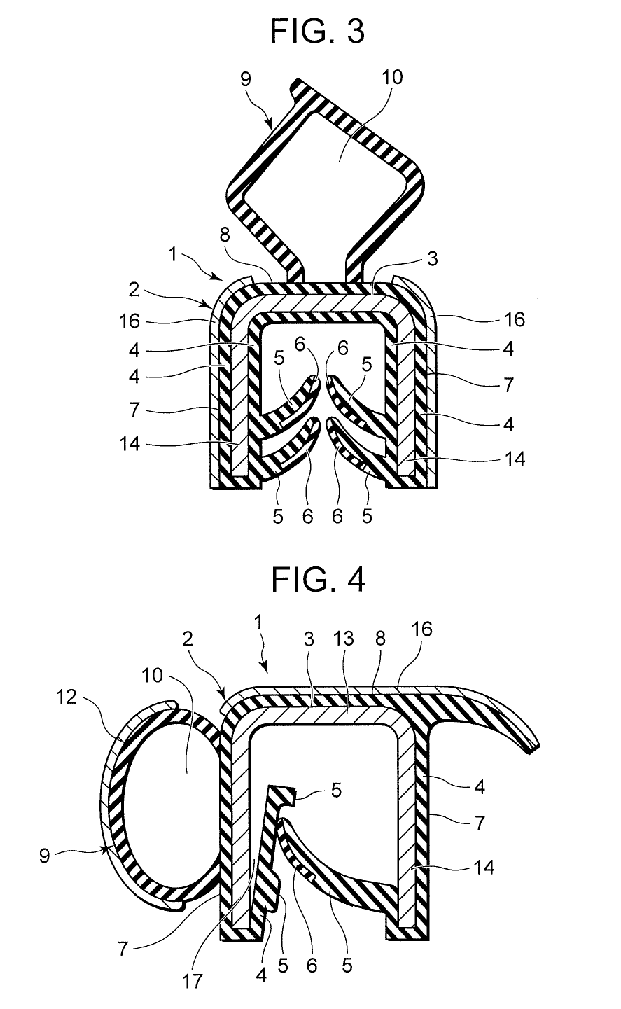

FIG. 3 shows a grip portion (2) formed by coating all of inside and outside peripheries of the core material (3) with a coating member (4), wherein a hollow seal portion (9) is formed outside a connecting portion (8) of the grip portion (2); holding portions (5) are formed inside side portions (7) in such a manner as to each project from the side portions (7); and contact portions (6) are formed on the holding portions (5) facing each other from both sides, at parts for abutting a flange (11).

In other words, in the molded product body (1) according to the embodiment shown in FIG. 3, a grip portion (2) is formed by coating all of inside and outside peripheries of the core material (3) with a coating member (4), wherein a hollow seal portion (9) is formed outside a connecting portion (8) of the grip portion (2); holding portions (5) are formed inside side portions (7) in such a manner that two holding portions (5), (5) project from each of the side portions (7), (7); and a contact portion (6) is formed on each of the holding portions facing each other from both sides, at a part for abutting a flange (11).

Furthermore, the molded product body (1) according to the embodiment shown in FIG. 3 has an additional construction of covering the outside of the side portions (7), (7) with epidermal layers (16), (16) of synthetic resin. The epidermal layers (16), (16) of synthetic resin is formed of a compound synthetic resin in which at least two types of resins selected from among high molecular weight polyethylene resin, ultra-high molecular weight polyethylene resin, olefin based thermoplastic elastomer resin, silicon resin, etc. are compounded, which makes the coefficient of friction small, thereby providing good scratch resistance. In this respect, the epidermal layers (16), (16) may be omitted, and it is also possible to omit only one of the epidermal layers (16), (16) of synthetic resin on both sides

FIG. 4 shows a hollow seal portion (9) formed outside a side portion (7) of a grip portion (2), and a non-heat-fusible portion (17) formed, partially without using heat-fusion, on the inner surface of the grip portion (2) that corresponds to the inner surface of the side portion (7) seen on the left side in FIG. 4.

In addition, a contact portion (6) is provided only on the long holding portion (5) in the same manner as that of the molded product body (1) according to the embodiment shown in FIG. 1. Here, it is also possible to provide a contact portion (6) on one or each of the two short holding portions (5), (5) formed on the side portion (7), seen on the left side in FIG. 4, which is provided with a non-heat-fusible portion (17) without heat-fusion.

Furthermore, the hollow seal portion (9) may take various shapes such as a square, a round, an ellipse and the like, as required, and may be formed at a desired location outside the connecting portion (8) or the side portion (7) of the core material (3).

Moreover, in order to enable the opening and shutting operations of doors and trunks, etc. to be performed smoothly, a sliding layer (12) of synthetic resin may be formed, as required, on a part of the outer surface of the hollow seal portion (9).

Also, the epidermal layer (16) of synthetic resin may be formed on a part exposed on an outer surface of the connecting portion (8) or the side portion (7) of the grip portion (2), as required.

The above-mentioned sliding layer (12) and the epidermal layer (16) are formed of a compound synthetic resin in which at least two types of resins selected from among high molecular weight polyethylene resin, ultra-high molecular weight polyethylene resin, olefin based thermoplastic elastomer resin, silicon resin, etc. are compounded such that the thickness thereof is in the range of 0.01 mm to 0.1 mm, thereby making the coefficient of friction small and providing good scratch resistance.

Further, the epidermal layer (16) may be formed of a synthetic resin such as high crystalline polypropylene, etc. so as to provide good glossiness and scratch resistance, and then, the thickness thereof may be formed in the range of 0.05 mm to 0.5 mm.

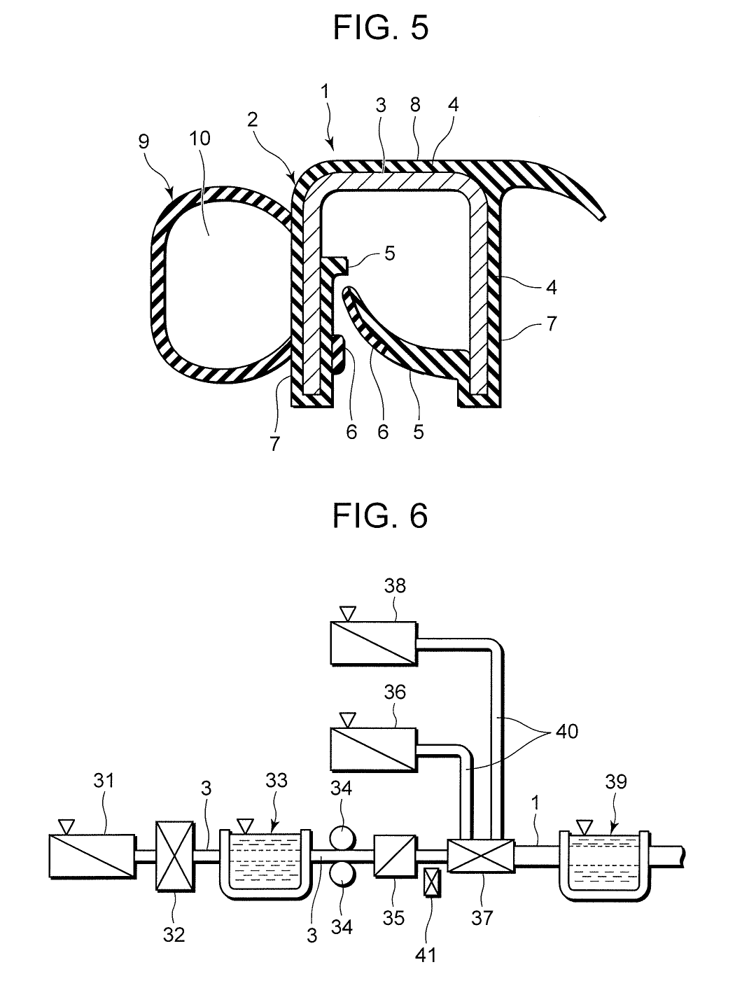

FIG. 5 shows a contact portion (6) formed on a long holding portion (5) seen on the right side in the Figure and also on a short holding portion (5) that is the lower of the two upper and lower short holding portions (5), (5) seen on the left side in the Figure. In other words, in the molded product body (1) according to the embodiment shown in FIG. 5, the long and short holding portions (5), (5) of a thermoplastic elastomer are formed inside the side portions (7) such that the long holding portion (5) projects from one of the side portions, while the short holding portions (5) project from the other. A contact portion (6) is formed on a part of the long holding portion (5) seen on the right side in FIG. 5, and is also formed throughout the entire area of the lower short holding portion (5), i.e., as a substitute for the lower short holding portion (5) on the left side in FIG. 5. In this respect, however, the contact portion (6) may be formed at another desired position, as required, for example, on a part of the lower short holding portion (5), or throughout the entire area or on a part of the upper short holding portion (5), or throughout the entire area or on part of the lower and upper short holding portions (5).

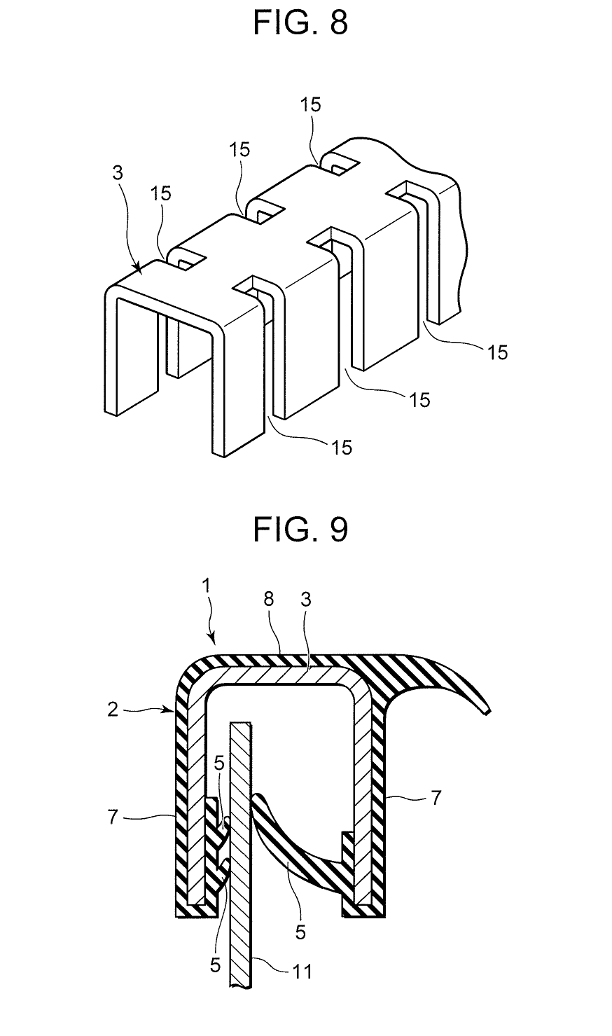

FIG. 6 shows a manufacturing method for continuously manufacturing a molded product body (1) based on a core material (3) of a hard synthetic resin, wherein a hard synthetic resin is injected into a first extrusion molding machine (31), and the core material (3) having a generally U-shaped cross-section is formed by a first mold die (32). Subsequently, the core material (3) passes through a first cooling tank (33) and then through a take-up roller (34), and opening areas (15) are cut out by a cutting machine (35) in desired various shapes, as shown in FIG. 8, in wall portions (14) and a bottom portion of the core material (3) having a generally U-shaped cross section.

In order to enhance the adhesive strength of the heat-fusion between the core material (3) and the coating member (4), a heating device (41) that radiates infrared rays or blows hot air is installed to heat the surface of the core material (3). After being heated, the core material (3) enters a second mold die (37), inside which a thermoplastic elastomer injected in and coming from a second extrusion molding machine (36) and being in the state of being fused for forming a coating member (4) and a holding portion (5) and a thermoplastic elastomer composition injected in and coming from a third extrusion molding machine (38) and being in the state of being fused for forming a contact portion (6) are co-extruded into an extrusion molded product (1), which goes through a second cooling tank (39), and is cut in a desired size.

Furthermore, in case of forming a hollow seal portion (9), a forth extrusion molding machine (not shown in the drawings) is added to ensure that inside the second mold die (37), the hollow seal portion (9) and the coating member (4) are co-extruded, with the hollow seal portion (9) being on the periphery of the coating member (4).

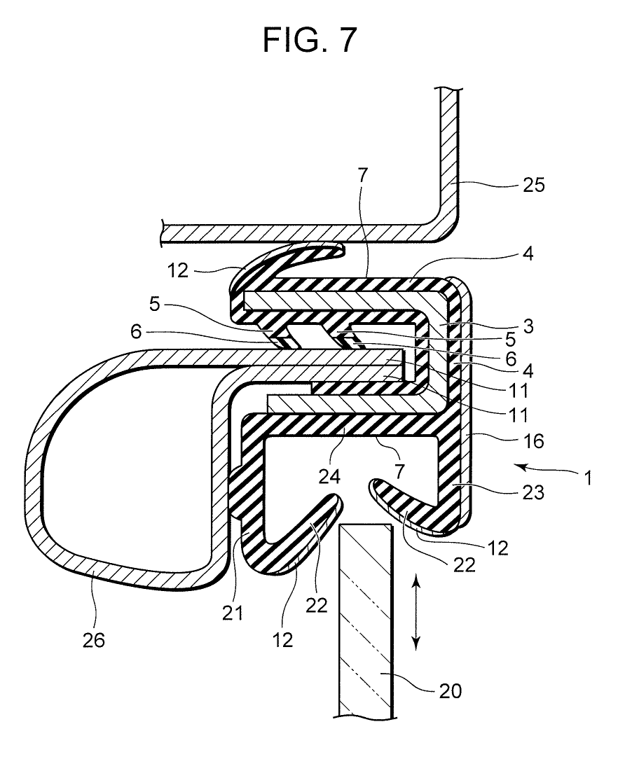

FIG. 7 shows a molded product body (1), in which a glass run channel (21) is integrally formed with a lower part of a grip portion (2), wherein a contact portion (6) is formed throughout the entire area of the distal end portion of each of holding portions (5) formed inside one of side portions (7), and there is neither a holding portion (5) nor a contact portion (6) formed on the other side portion (7).

Then, a door glass (20) is sealed by lips (22) of a glass run channel (21), but in order to ensure smooth up and down opening/shutting operation of the door glass (20), a sliding layer (12) of synthetic resin having a small coefficient of friction is formed on the surface of each of the lips (22). Furthermore, an epidermal layer (16) having good scratch resistance may be formed on a surface exposed outside.

In this respect, although not shown in the drawings, the epidermal layer (16) may be formed directly on a surface of the core material (3).

The sliding layer (12) and the epidermal layer (16) of a synthetic resin are formed of a compound synthetic resin in which at least two types of resins selected from among high molecular weight polyethylene resin, ultra-high molecular weight polyethylene resin, olefin based thermoplastic elastomer resin, silicon resin, and so forth are compounded, thereby making the coefficient of friction small and providing good scratch resistance.

Further, the epidermal layer (16) may be formed of a synthetic resin such as high crystalline polypropylene, etc. so as to provide good glossiness and scratch resistance.

FIG. 8 shows that gap portions (15) are cut out and formed in the core material (3).

FIG. 9 shows a conventional embodiment of a molded product body (1) not having a contact portion (6) formed on a surface of a holding portion (5).

### <A Thermoplastic Elastomer Composition Forming Each of the Contact Portions (6)>

Next, a thermoplastic elastomer composition forming each of the contact portions (6) will be described.

### Component (a): Essential Component

A component (a) is a block copolymer comprising at least two polymer blocks A mainly comprising a vinyl aromatic compound and at least one polymer block B mainly comprising a conjugated diene compound, or a product obtained by hydrogenating the block copolymer, or a mixture thereof. Examples thereof can include vinyl aromatic compound-conjugated diene compound block copolymers having structures, such as A-B-A, B-A-B-A, and A-B-A-B-A, and/or hydrogenated products thereof.

The above (hydrogenated) block copolymer (here, a (hydrogenated) block copolymer means a block copolymer and/or a hydrogenated block copolymer) comprises 5 to 60% by weight, preferably, 20 to 50% by weight, of a vinyl aromatic compound.

Preferably, the polymer block A mainly comprising a vinyl aromatic compound comprises only a vinyl aromatic compound, or is a copolymer block of 50% by weight or more, preferably 70% by weight or more, of a vinyl aromatic compound, and a conjugated diene compound, or a hydrogenated product thereof.

Preferably, the polymer block B mainly comprising a conjugated diene compound comprises only a conjugated diene compound, or is a copolymer block of 50% by weight or more, preferably 70% by weight or more, of a conjugated diene compound, and a vinyl aromatic compound, or a hydrogenated product thereof.

In each of the polymer block A mainly comprising a vinyl aromatic compound, and the polymer block B mainly comprising a conjugated diene compound, the distribution of the vinyl compound or the conjugated diene compound in the molecular chain may be random, tapered (the monomer component increases or decreases along the molecular chain), partially blocked, or in any combination thereof.

When there are two or more polymer blocks A mainly comprising a vinyl aromatic compound, or two or more polymer blocks B mainly comprising a conjugated diene compound, each may have the same structure or a different structure.

As the vinyl aromatic compound constituting the (hydrogenated) block copolymer, one or two or more can be selected, for example, from styrene, α-methyl styrene, vinyltoluene, p-tert-butyl styrene, and the like. Among them, styrene is preferred. As the conjugated diene compound, one or two or more are selected, for example, from butadiene, isoprene, 1,3-pentadiene, 2,3-dimethyl-1,3-butadiene, and the like. Among them, butadiene, isoprene, and combinations thereof are preferred.

The micro-bond in the polymer block B mainly comprising a conjugated diene compound can be arbitrarily selected.

In a butadiene block, preferably, the 1, 2-micro-bond accounts for 20 to 50%, particularly 25 to 45%.

In a polyisoprene block, preferably, 70 to 100% by weight of the isoprene compound has a 1, 4-micro-bond, and at least 90% or more of aliphatic double bonds based on the isoprene compound are hydrogenated.

For the weight average molecular weight of the (hydrogenated) block copolymer having the above structure used in the present invention, the lower limit value is in the range of 5,000 or more, preferably 10,000 or more, and more preferably 80,000 or more, and the upper limit value is in the range of 400,000 or less, preferably 300,000 or less, and more preferably 150,000 or less. The molecular weight distribution (the ratio of the weight average molecular weight (Mw) to the number average molecular weight (Mn) (Mw/Mn)) is preferably 10 or less, further preferably 5 or less, and more preferably 2 or less. The molecular structure of the (hydrogenated) block copolymer may be any of linear, branched, radial, or any combination thereof.

### Component (b): Essential Component

The component (b) used in the present invention includes a homopolymer of crystalline ethylene or propylene, or a crystalline copolymer mainly comprising the ethylene or propylene. They include crystalline ethylene polymers, such as high density polyethylene, low density polyethylene, and ethylene-butene-1 copolymer, and crystalline propylene polymers, such as isotactic polypropylene, propylene-ethylene copolymer, propylene-butene-1 copolymer, and propylene-ethylene-butene-1 ternary copolymer. Among them, polypropylene resins are preferred.

### Component (c): Essential Component

A rubber softener component (c) used in the present invention may be a non-aromatic rubber softener component or an aromatic rubber softener component, and an ester plasticizer can also be used. But, particularly, non-aromatic mineral oil and an ester plasticizer are preferred. Examples of the non-aromatic mineral oil softener include a paraffin softener in which the number of paraffin chain carbons accounts for 50% or more of the total number of carbons.

### Component (d): Essential Component

A petroleum resin component (d) used in the present invention is a resin obtained by copolymerizing, as a raw material, unsaturated hydrocarbon obtained in various processes, particularly a naphtha decomposition process, in the petroleum refining industry and the petrochemical industry. Examples thereof can include aliphatic petroleum resins comprising C5 fractions as a raw material, aromatic petroleum resins comprising C9 fractions as a raw material, alicyclic petroleum resins comprising dicyclopentadiene as a raw material, and terpene resins, and copolymerized petroleum resins obtained by copolymerizing two or more thereof, and further, hydrogenated petroleum resins obtained by hydrogenating these, and the like. The hydrogenated petroleum resins of the above resins are obtained by hydrogenating the above resins by methods known to those skilled in the art. Specifically, commercial products, such as I-MARV (a hydrogenated petroleum resin) manufactured by Idemitsu Kosan Co., Ltd., ARKON (a hydrogenated petroleum resin) manufactured by Arakawa Chemical Industries, Ltd., Clearon (a hydrogenated terpene resin) manufactured by YASUHARA CHEMICAL Co., Ltd., and Escorez (an aliphatic hydrocarbon resin) manufactured by Tornex Co., Ltd., can be used.

The thermoplastic elastomer composition comprises the above-mentioned components (a), (b), (c) and (d), and these components are compounded such that the thermoplastic elastomer composition comprises:

30 to 60 parts by weight of component (a);

10 to 30 parts by weight of component (b); and

25 to 55 parts by weight of component (c); and in addition to (a)+(b)+(c)=100 parts by weight;

3 to 15 parts by weight of component (d);

preferably,

40 to 60 parts by weight of component (a);

10 to 30 parts by weight of component (b); and

25 to 45 parts by weight of component (c); and in addition to (a)+(b)+(c)=100 parts by weight; 3 to 15 parts by weight of component (d).

### Component (e): Inorganic Filler

In the thermoplastic elastomer composition for forming a contact portion (6) of the extrusion molded product having a core material according to the present invention, an inorganic filler component (e) can be compounded, as required, as a component (e) to be added to the above-mentioned components (a) to (d). The component (e) has the effect of improving some properties, such as compressive permanent strain, of the molded product obtained from the thermoplastic elastomer composition, as well as an economical advantage due to an increase in amount. Examples of the component (e) include wollastonite, chlorite, calcium carbonate, talc, silica, diatomaceous earth, barium sulfate, magnesium carbonate, magnesium hydroxide, mica, clay, titanium oxide, carbon black, glass fiber, hollow glass balloons, carbon fiber, calcium titanate fiber, natural silicic acid, synthetic silicic acid (white carbon), and the like. Among these, calcium carbonate, wollastonite, chlorite, and talc are particularly preferred.

The content of the component (e) is preferably 1 to 20 parts by weight with respect to the above-mentioned (a)+(b)+(c)=100 parts by weight.

A usage example of the materials of the molded product body (1) used in the present invention will be described. The core material (3) having a generally U-shaped cross section comprises a metal or hard synthetic resin. An olefinic resin or a mixed synthetic resin obtained by mixing an olefinic resin with 20 to 50% by weight of powder such as talc, having a type A durometer hardness (JIS K6253, a value after 15 seconds) of 90 or more, is used as the hard synthetic resin to increase rigidity and decrease the coefficient of linear expansion. Usage examples of the metal include iron, aluminum, stainless steel and so forth.

Further, usage examples of the material of the thermoplastic elastomer forming the coating member (3) and the holding portion (5) include an olefinic thermoplastic elastomer or a styrenic thermoplastic elastomer having a type A durometer hardness (JIS K6253, a value after 15 seconds) of 40 to 80, preferably 45 to 65.

Also, usage examples of the material of the thermoplastic elastomer composition forming the contact portion (6) include a thermoplastic elastomer composition having a type A durometer hardness (JIS K6253, a value after 15 seconds) of 40 to 80, wherein component (a) as a styrenic rubber component is mainly compounded.

Further, a type A durometer hardness (JIS K6253, a value after 15 seconds) of 20 to 50 is used for the thermoplastic elastomer forming the hollow seal portion (9).

Descriptions will be made on an Example of the thermoplastic elastomer composition, which is named Material-A here, forming the contact portion (6) of the extrusion molded product having a core material according to the present invention. However, the example will be described only as an example, and thus, the present invention is not limited to it, and can be altered, as required, within the scope of the technical idea of the present invention.

Material-A, i.e., the thermoplastic elastomer composition for forming the contact portion (6) according to an example is produced by compounding the under-mentioned components such that component (d) is compounded with component (a)+component (b)+component (c)=100 parts by weight.

### Component (a)

50 parts by weight of a styrene-isoprene block copolymer having a styrene content of 30% by weight, an isoprene content of 70% by weight, a weight average molecular weight of 260,000, and a molecular weight distribution of 1.3, and with 90% or more hydrogenation, trade name: SEPTON 4055, manufactured by KURARAY CO., LTD.

### Component (b)

15 parts by weight of a polypropylene random copolymer having a MFR (230° C., 21.18 N) of 7 g/10 min., trade name FW4BT, manufactured by Japan Polypropylene Corporation

### Component (c)

35 parts by weight of a non-aromatic hydrocarbon rubber softener (paraffin oil) having a weight average molecular weight of 540, trade name: Diana Process Oil PW-90, manufactured by Idemitsu Kosan Co., Ltd. (In this respect, as described above, component (a)+component (b)+component (c)=100 parts by weight)

### Component (d)

10 parts by weight of a petroleum resin having a softening point of 140° C., an average molecular weight of 910, and a density of 1.03, trade name: I-MARV P-140, manufactured by Idemitsu Kosan Co., Ltd.
A Pellet-like material obtained by compounding, and melting and kneading the above components was used.

By using the Material-A, i.e., the thermoplastic elastomer composition comprising the above-mentioned components as an example and a comparison objective Material-B, the following test methods were performed, and the values of properties in Table 1 were obtained. In this respect, the numeric values in the Table indicate the values of properties of the thermoplastic elastomer used for the holding portion (5).

### 1. Hardness:

According to JIS K 6253, using a 6.3 mm thick press sheet as a test piece, the type A durometer hardness was measured, and the value after 15 seconds was obtained. The measurement temperature was 23° C.

### 2. Tensile Strength, 100% Modulus, and Elongation:

The measurement of tensile strength, 100% modulus, and elongation conformed to JIS K 6301. For the test piece, a 2 mm thick press sheet was punched in a No. 3 dumbbell shape for use. The tensile speed was 500 mm/min. The measurement temperature was 23° C.

3. Coefficient of static friction:

Measuring device; “HEIDON (manufactured by SHINTO Scientific Co., Ltd.)”

Slipping object; a metal ball

Test piece; an extruded tape with 1 mm thickness

Measuring condition;

Vertical load; 100 g

Test speed; 200 mm/min

Travelling distance; measured under a condition of 50 mm.

TABLE 1

| | Material-A | Material-B |
|---|---|---|
| Hardness | 60 | 50 |
| Tensile strength (MPa) | 8.8 | 6.1 |
| 100% modulus (MPa) | 1.5 | 1.7 |
| Elongation (%) | 680 | 520 |
| Coefficient of static | 1.8 | 0.9 |
| friction | | |

Next, Table 2 shows comparisons between the holding force in case of providing a contact portion (6) on the holding portion (5) of the molded product body (1) and the holding force in case of not providing such a contact portion (6).

In Example 1, a contact portion (6) according to the present invention is formed on the holding portion (5). The holding portion (5) of Comparative Example 1 is merely conventional, and no contact portion (6) is formed thereon.

Measurements of the holding forces were made on a part, i.e., a molded product provided one week after its molding and on a part, i.e., a molded product provided after heat aging test (or on a part, i.e., a molded product that had been kept at 80° C. in an oven for 2,000 hours before it was taken out).

As is clear from Table 2, it can be understood that the holding force according to Example 1 with a contact portion (6) formed on a holding portion (5) is larger than that of Comparative Example 1 with a mere conventional holding portion (5), and provides a solution for the problem that the molded product body (1) falls off the flange easily.

TABLE 2

| | | | | Holding force | |
|---|---|---|---|---|---|
| | | | Holding | (after heat | |
| | Constituent | | force | aging) | Evalu- |
| | materials | | (N/100 mm) | (N/100 mm) | ation |
| Example 1 | Holding | Material | 75 | 70 | Passed |
| | portion | B | | | |
| | Contact | Material | | | |
| | portion | A | | | |
| Compar- | Holding | Material | 53 | 48 | Failed |
| ative | portion | B | | | |
| Example 1 | Contact | Non | | | |
| | portion | | | | |

Here, in case that the appraisal standard for the holding force is set at 60N/100 mm, Example 1 has no possibility of the aforesaid falling-off, because Table 2 shows that an ordinary part (a molded product provided one week after its molding) and a part provided after heat aging test have the holding forces of 75N/100 mm and 70N/100 mm respectively, both exceeding 60N/100 mm.

In contrast, Comparative Example 1 is likely to cause the aforesaid falling off the flange, because Table 2 shows that an ordinary part and a part provided after heat aging test have the holding forces of 53N/100 mm and 48N/100 mm respectively, both falling below 60N/100 mm.

1. An extrusion molded product having a core material for mounting thereof on a flange (5) around the periphery of an opening of an automobile body, such as a door, a trunk and a back door, wherein a molded product body (1) comprises a grip portion (2) having a generally U-shaped cross section formed by a core material (3) and a coating member (4), wherein the grip portion (2) has holding portions (5) formed inside side portions (7) thereof, wherein at least one of the holding portions (5) has a contact portion (6) formed integrally with the holding portion (5) on a portion abutting a flange (11), wherein the coefficient of static friction of the contact portion (6) is larger than that of the holding portion (5), and wherein the thermoplastic elastomer composition forming the contact portion (6) comprises:
30 to 60 parts by weight of component (a): a block copolymer comprising at least two polymer blocks A mainly comprising a vinyl aromatic compound and at least one polymer block B mainly comprising a conjugated diene compound, and/or a hydrogenated block copolymer obtained by hydrogenating the block copolymer;
10 to 30 parts by weight of component (b): a homopolymer of crystalline ethylene or propylene, or a crystalline copolymer mainly comprising the ethylene or propylene; and
25 to 55 parts by weight of component (c): a rubber softener; and in addition to the above-mentioned
(a)+(b)+(c)=100 parts by weight;
3 to 15 parts by weight of component (d): a petroleum resin and/or a hydrogenated petroleum resin obtained by hydrogenation.

2. The extrusion molded product having a core material according to claim 1, wherein the contact portion (6) is formed like a layer on the surface of the tip side of the holding portion (5).

3. The extrusion molded product having a core material according to claim 1, wherein the contact portion (6) is formed throughout the entire area of the distal end portion of the holding portion (5) or throughout the entire area of the holding portion (5).

4. The extrusion molded product having a core material according to claim 1, wherein the contact portion (6) is formed on the holding portion (5) only on one of the side portions (7).

5. The extrusion molded product having a core material according to claim 1, wherein the contact portion (6) is formed on the holding portions (5) on both of the side portions (7).

6. The extrusion molded product having a core material according to claim 1, wherein the thermoplastic elastomer forming the coating member (4) and the holding portion (5) has a type A durometer hardness of 45 to 65.

7. The extrusion molded product having a core material according to claim 1, wherein a hollow seal portion (9) is formed on an outer periphery of the grip portion (2).

8. The extrusion molded product having a core material according to claim 1, wherein core material (3) having a generally U-shaped cross section is formed of a synthetic resin or a metal.
